(19) United States
(12) Patent Application Publication
(10) Pub. No.: US 2008/0181081 A1
(43) Pub. Date: Jul. 31, 2008

(54) OPTICAL MULTI MODE TRANSMISSION BETWEEN A PROCESSOR AND A SET OF MEMORIES

(76) Inventors: PETER MAYER, Neubiberg (DE); Wolfgang Spirkl, Germering (DE); Markus Balb, Munich (DE); Christoph Bilger, Munich (DE); Martin Brox, Munich (DE); Thomas Hein, Munich (DE); Michael Richter, Ottobrunn (DE)

Correspondence Address: PATTERSON & SHERIDAN, LLP;Gero McClellan / Qimonda, 3040 POST OAK BLVD.,, SUITE 1500, HOUSTON, TX, 77056, US

(21) Appl. No.: 11/669,829

(22) Filed: Jan. 31, 2007

(51) Int. Cl. G11B 7/00

(52) U.S. Cl. 369/100

(57) ABSTRACT

A method and apparatus for accessing one or more memory devices using an optical multi-mode signal. The method includes providing an optical multi-mode signal including a first mode and a second mode and transmitting the optical multi-mode signal via an optical multi-mode bus to the one or more memory devices. The first mode is used to perform a first access to the one or more memory devices and the second mode is used to perform a second access to the one or more memory devices.

### BACKGROUND OF THE INVENTION

Computer systems typically include a processor for processing data and instructions and one or more memories for storing the data and instructions. For example, a graphics processing unit (GPU), which may be used to render complex three-dimensional images, may be connected in parallel to multiple individual memories. By connecting the GPU to the memories in parallel, the GPU may access each of the memories simultaneously, thereby increasing the amount of data and instructions that can be transferred to or from the memories at a time (referred to as the memory bandwidth).

Typically, the memories may be connected to the GPU via electrical signal lines, for example, on a printed circuit board. Where a large number of memories are connected to the GPU in parallel, the distance (e.g., on the printed circuit board) between the GPU and memories may be large in order to provide the space needed for the large number of electrical signal lines. Where the distance between the GPU and memories is increased, the cost of the electrical signal lines used to connect the GPU and the memories may also be increased. Furthermore, because of the inherent resistance and capacitance in the signal lines, signals being transmitted across the longer signal lines may be subject to signal degradation (e.g., dispersion and/or signal losses) and increased latency (e.g., the signals may take longer to propagate across the signal lines). In some cases, to compensate for signal degradation across the signal lines, the power used to transmit signals across the signals lines may be increased.

Thus, as described above, in some cases, where multiple memories are connected to a GPU in parallel, the resulting configuration may suffer from signal degradation, increased latency, and increased power consumption. Accordingly, what is needed are improved methods and apparatuses for connecting multiple memories to a processor.

### SUMMARY OF THE INVENTION

Embodiments of the invention provide a method and apparatus for accessing one or more memory devices using an optical multi-mode signal. In one embodiment, the method includes providing an optical multi-mode signal including a first mode and a second mode. The method also includes transmitting the optical multi-mode signal via an optical multi-mode bus to the one or more memory devices. The first mode is used to perform a first access to the one or more memory devices and the second mode is used to perform a second access to the one or more memory devices.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a graphical processing unit (GPU) connected to four memory devices via an optical bus, according to an embodiment of the invention.

FIG. 2 illustrates exemplary operations performed during communication between a GPU and a plurality of memory devices according to an embodiment of the invention.

FIG. 3 illustrates a GPU connected to a memory module via an optical bus, according to an embodiment of the invention.

FIG. 4 is illustrates exemplary operations performed by memory receiving communications from a GPU according to an embodiment of the invention.

FIGS. 5A and 5B illustrate simultaneous communications between a GPU and memory via an optical bus according to an embodiment of the invention.

FIG. 6 illustrates two GPUs connected to a dual port memory module via an optical bus according to an embodiment of the invention.

### DETAILED DESCRIPTION OF THE PREFERRED EMBODIMENT

Embodiments of the invention provide a method and apparatus for accessing one or more memory devices using an optical multi-mode signal. In one embodiment, the method includes providing an optical multi-mode signal including a first mode and a second mode. The method also includes transmitting the optical multi-mode signal via an optical multi-mode bus to the one or more memory devices. The first mode is used to perform a first access to the one or more memory devices and the second mode is used to perform a second access to the one or more memory devices.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and, unless explicitly present, are not considered elements or limitations of the appended claims.

While described below with respect to graphical processing units, embodiments of the invention may be used with any type of processor, controller, or other circuitry. Similarly, the memory devices described below may include any type of memory device including volatile memory devices such as static random access memory (SRAM) devices and dynamic random access memory (DRAM) devices and also nonvolatile memory devices such as flash memory devices and magnetic random access memory (MRAM) devices.

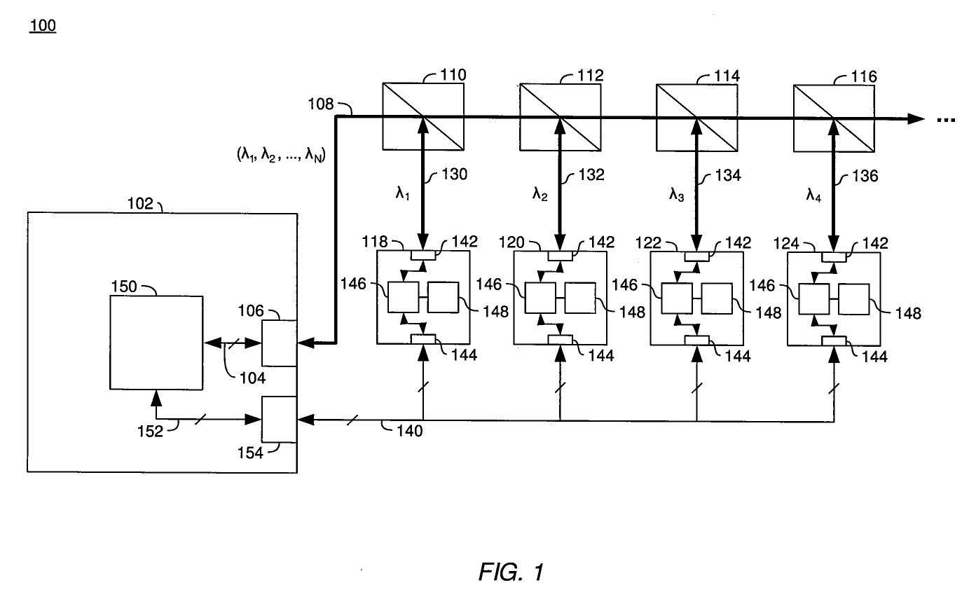

FIG. 1 illustrates a system 100 which includes an optical multi-mode bus 108 connecting a graphical processing unit (GPU) 102 to multiple memory devices 118 . . . 124. In the depicted embodiment, control circuitry 150 in the GPU 102 may generate electrical signals which are transmitted via an internal bus 104. The electrical signals may indicate commands, addresses, and/or data which are to be transmitted to on or more of the four memory devices 118 . . . 124. The electrical signals may include requests to read data from a particular memory, write data to a particular memory, or issue a command to a particular memory.

In one embodiment, the electrical signals provided by the control circuitry 150 of the GPU 102 may be converted to optical signals by a wavelength division multiplexer (WLDM) 106. The wavelength division multiplexer 106 may convert the GPU's internal electrical signals received via the internal bus 104 into different optical modes to be transmitted via the optical multi-mode bus 108. In one embodiment, each of the different modes may be different wavelengths of light (e.g., λ₁, λ₂ . . . λ_{N}). For example, each mode may be provided as a different color, such as red, green, blue, or purple. Embodiments of the invention may be utilized with any wavelength division multiplexer 106, and the wavelength division multiplexer 106 may also provide de-multiplexing capabilities. Furthermore, embodiments of the invention may be utilized with any type of wavelength division multiplexing, including coarse wavelength division multiplexing and dense wavelength division multiplexing.

In one embodiment, each different mode may be used to communicate between the GPU 102 and a given memory device 118 . . . 124. As illustrated in FIG. 1, beam splitters/filters 110 . . . 116 may be used to ensure that each memory device 118 . . . 124 receives only the commands and data transmitted by the GPU 102 in a particular mode. For example, the beam splitter/filters 110-116 may provide a given memory device with its corresponding mode (λ₁, λ₂ . . . λ_{N}) via an optical bus 130 . . . 136, while allowing modes that do not correspond to the memory device to propagate along the optical multi-mode bus 108. The beam splitter/filters 110 . . . 116 may also ensure that data transmitted from a given memory device 118 . . . 124 to the GPU is received by the GPU 102 and not other memories.

In one embodiment of the invention, optical signals received via optical busses 130 . . . 136 may be converted by optical transmitter/receiver circuitry 142 in each memory device 118 . . . 124 into electrical signals which are provided to control circuitry 146 within each memory device. The control circuitry 146 in each memory device may then access one or more memory arrays 148 within the memory device. In some cases, the control circuitry 146 may receive data from the one or more memory arrays 148 to be transmitted to the GPU 102. The control circuitry 146 may also provide other information (e.g., status register information) to the GPU 102. In such cases, the control circuitry 146 may provide electrical signals to the transmitter/receiver circuitry 142 which may convert the electrical signals into optical signals which are transmitted across a corresponding optical bus 140 . . . 136 for the memory device.

In one embodiment, when optical signals from a memory device 118 . . . 124 are received via an optical bus 130 . . . 136, the beam splitter/filter 110 . . . 116 for the optical bus 130 . . . 136 may transmit the optical signals across the optical multi-mode bus 108 to the GPU 102 where the wavelength division multiplexer 106 may de-multiplex the optical signal from the memory device and provide corresponding electrical signals via internal bus 104 to the GPU control circuitry 150. In one embodiment, each memory device 118 . . . 124 may provide optical signals to the GPU 102 using the same mode (λ₁, λ₂ . . . λ_{N}) which the GPU 102 uses to communicate with the memory device. When receiving optical signals from the memory devices 118 . . . 124, the wavelength division multiplexer 106 may use the mode(s) of the received optical signals to determine which memory device(s) are transmitting data to the GPU 102.

In one embodiment, because multiple modes may be transmitted via the optical multi-mode bus 108 and filtered simultaneously by the beam splitter/filters 110 . . . 116, the GPU 102 may be able to access two or more of the memory devices 118 . . . 124 simultaneously across the optical multi-mode bus 108 without interference between the separate accesses. For example, the GPU 102 may issue a first access command to the first memory device 118 via the optical multi-mode bus 108 using a first mode (λ₁) and may also simultaneously issue a second access command to the second memory device 120 via the optical multi-mode bus 108 using a second mode (λ₂).

In another embodiment of the invention, the GPU 102 and each of the memory devices 118 . . . 124 may be configured to perform full duplex communication (e.g., transmitting and receiving simultaneously) by using a first mode for each memory device 118 . . . 124 for transmitting information to that memory device 118 . . . 124 from the GPU 102 and using a second mode for each memory device 118 . . . 124 for receiving information from that memory device 118 . . . 124 by the GPU 102. For example, the GPU 102 may use a first mode (λ₁) to transmit information to a first memory device 118 and a second mode (λ₂) to transmit information to a second memory device 120. The first memory device 118 may be configured to use a third mode (λ₁′) to transmit information to the GPU 102 and the second memory device 120 may be configured to use a fourth mode (λ₂′) to transmit information to the GPU 102. Because each mode may be transmitted simultaneously on the multi-mode signal bus 108, the first and second memory devices 118, 120 may communicate with the GPU 102 using a total of four communications streams (e.g., upstream and downstream from each memory device 118, 120 to the GPU 102). Where each of the four memory devices 118 . . . 124 utilizes separate modes for transmission and reception, eight communication streams may be used to communicate between the GPU 102 and the memory devices 118 . . . 124.

In one embodiment of the invention, additional modes may be provided for performing communications between the GPU 102 and two or more memory devices 118 . . . 124. For example, a broadcast mode (e.g., λ₅) may be provided. The GPU 102 may use the broadcast mode to transmit commands and/or data (e.g., configuration settings, reset commands, access commands, etc.) to all of the memory devices 118 . . . 124 simultaneously. Other modes may also be provided, for example, to access only a given number of memories. For example, a mode may be provided which is used to access only the first memory 118 and second memory 120. Such a mode may allow the memory devices 118, 120 accessed using the common access mode to be accessed as a single memory bank. For example, a bank address bit transmitted using the common access mode may indicate a single one of the two memory devices 118, 120 which is to be accessed by a given access command. Also, in one embodiment of the invention, additional modes may be provided to perform inter-memory communication. For example, the first memory device 118 may use a first inter-memory mode (e.g., λ₆) to access the second memory device 120 and a second inter-memory mode (e.g., λ₇) to access the third memory device 122.

In one embodiment of the invention, the GPU 102 may be configured to access the memory devices 118 . . . 124 using electrical signals transmitted via an electrical bus 140 in addition to optical signals transmitted via the optical multi-mode bus 108. For example, the electrical bus 140 may be used to transmit low-speed signals or power supply signals while the optical multi-mode bus 108 may be used to transmit high-speed signals. The electrical signals provided by the GPU 102 may be generated by the control circuitry 152 and provided to driver/receiver circuitry 154 via an internal electrical bus 152. The electrical signals may then be transmitted to one or more memory devices 118 . . . 124 via the external electrical bus 140.

A given memory device may receive the electrical signals via electrical driver/receiver circuitry 144 and provide the received electrical signals to control circuitry 146 which may use the electrical signals (e.g., in conjunction with information received via optical multi-mode bus 108) to access one or more memory arrays 148. Each memory device 118 . . . 124 may also be configured to transmit electrical signals to the GPU 102 using driver/receiver circuitry 144 and the external data bus 140. The GPU 102 may receive the electrical signals via driver/receiver circuitry 154 and provide the electrical signals to the GPU control circuitry 150 using the internal electrical bus 152.

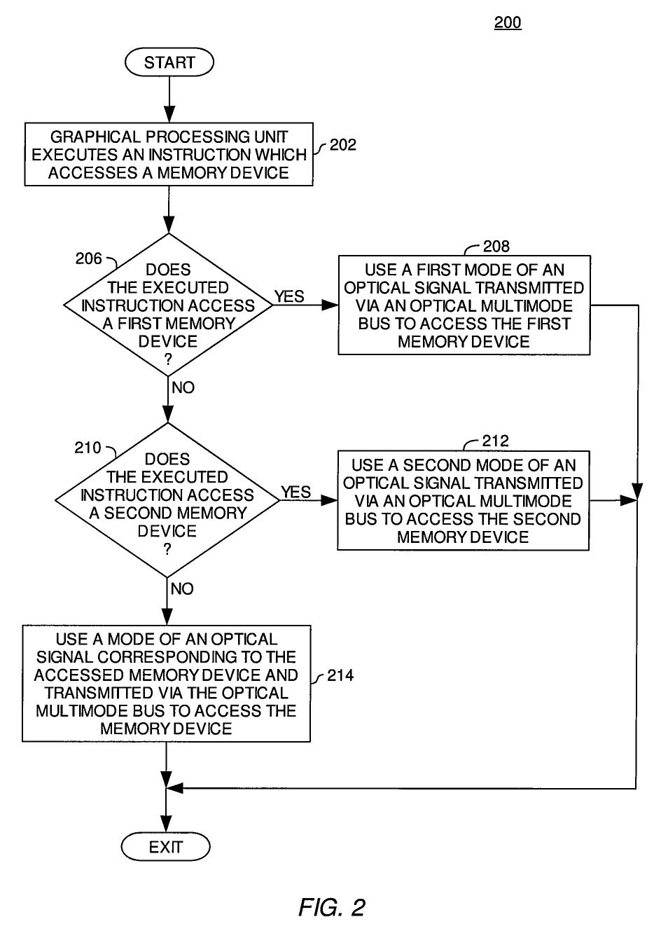

FIG. 2 illustrates a method 200 that may be performed to allow the GPU 102 to communicate with the one or more memory device 118-124 according to one embodiment of the invention. The method 200 begins at step 204 where the GPU 102 may execute an instruction which accesses at least one memory 118-124. The method 200 may then proceed to step 206, where a determination is made as to whether the executed instruction accesses the first memory device 118. If the executed instruction accesses the first memory device 118, a first mode (λ₁) of an optical signal transmitted via the optical multi-mode bus 108 may be used to access the first memory device 118 at step 208.

If the executed instruction does not include an access instruction for accessing the first memory device 118, the method 200 may proceed to step 210, where a determination is made as to whether the executed instruction accesses the second memory device 120. If the executed instruction accesses the second memory device 120, then at step 212 a second mode (λ₂) of an optical signal transmitted via the optical multi-mode bus 108 may be used to access the second memory device 120. If the executed instruction accesses another memory device, then a mode (e.g., λ₃, λ₄, etc.) of the optical signal corresponding to the accessed memory device (e.g., the third memory device 122, the fourth memory device 124, or another memory device) may be used to access the other memory device. The optical signal may be transmitted via the optical multi-mode bus 108 at step 214.

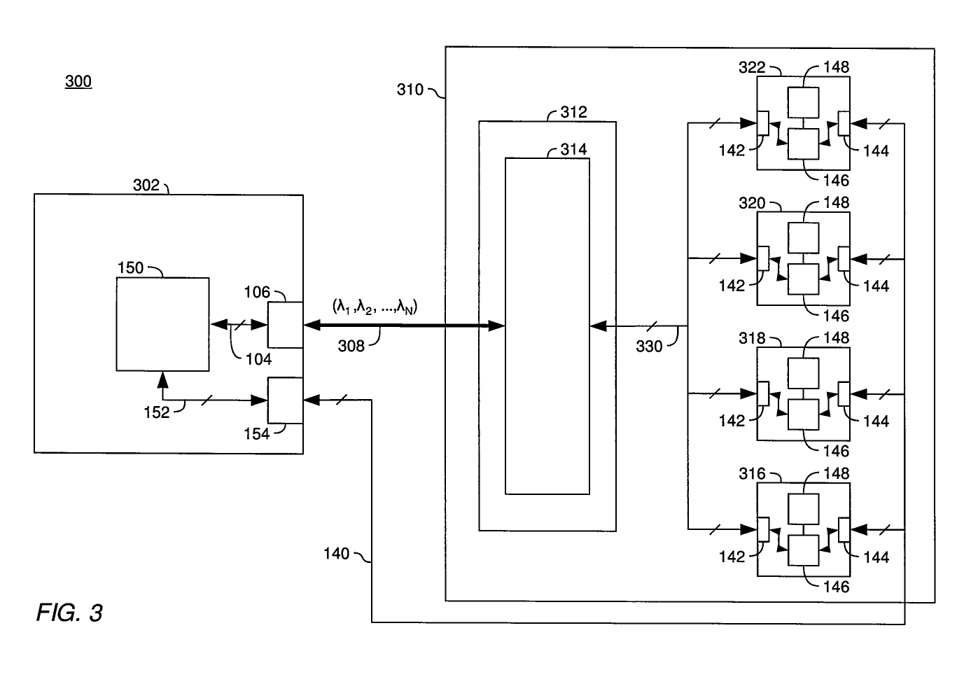

In one embodiment of the invention, wavelength division multiplexing may be used to communication with multiple memory devices included, for example, in a single memory module. In some cases, by using a single optical multi-mode bus to communicate with the multiple memory devices, connections between a GPU and memory module containing the memory devices may be reduced. FIG. 3 illustrates a system 300 in which a graphical processing unit (GPU) 302 communicates with a memory module 310 through an optical multi-mode bus 308 according to one embodiment of the invention.

In one embodiment, control circuitry 150 in the graphical processing unit 302 may generate electrical signals and provide the electrical signals via an internal bus 104 to a wavelength division multiplexer 106. The electrical signals may, for example, indicate commands and data to be provided to memory devices 316 . . . 322 in a memory module 310. In one embodiment, the memory module 310 may also include an optical interface device 312 containing a wavelength division multiplexer 314.

When the memory module 310 receives an optical multi-mode transmission (e.g., including modes λ₁, λ₂, etc.) from the graphical processing unit 302, the optical interface device 312 may separate the multi-mode transmission into separate electrical signals for each of the memory devices 316 . . . 322 which may be provided to the individual memories 316 . . . 322 via an electrical bus 330. For example, the wavelength division multiplexer 106 may separate the multi-mode transmission in its one or more constituent modes, with each mode (λ₁, λ₂, etc.) providing commands and/or information to a corresponding one of the memory device 316 . . . 322. In some cases, as described above, separate modes (e.g., λ₁, λ₁′) may also be provided for upstream and downstream communication with respect to a single memory device, and for broadcasting commands and/or information to two or more memory devices. In general, the optical interface device 312 and wavelength division multiplexer may use any appropriate components including beam splitters and filters to perform communications between the GPU 302 the memory devices 316 . . . 322.

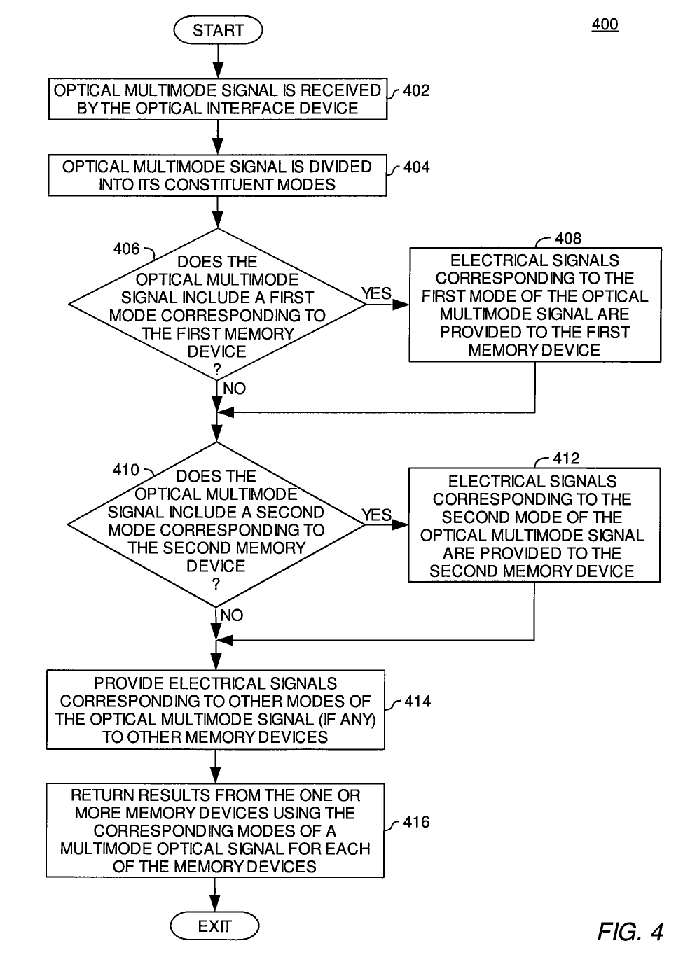

FIG. 4 depicts a method 400 for communicating between a GPU 302 and memory devices 316 . . . 322 using an optical interface device 312 according to one embodiment of the invention. The method 400 begins at step 402 where an optical multi-mode signal is received by the optical interface device 312. At step 404, the optical multi-mode signal is divided into its constituent modes. At step 406, a determination may be made of whether the optical multi-mode signal includes a first mode (λ₁) corresponding to the first memory device 316. If so, then at step 408, electrical signals corresponding to the first mode (λ₁) of the optical multi-mode signal may be provided to the first memory device 316, for example, via electrical bus 330.

At step 410, a determination may be made of whether the optical multi-mode signal includes a second mode (λ₂) corresponding to the second memory device 318. If so, then at step 412, electrical signals corresponding to the second mode of the optical multi-mode signal may be provided to the second memory device 318, for example, via electrical bus 330. At step 414, other electrical signals corresponding to other modes (e.g., λ₃, λ₄, etc.) of the optical multi-mode signal (if any are received) may be provided to other memory devices (e.g., memory devices 320, 322).

At step 416 the results from one or more memory devices 316 . . . 322 may be returned (if there are any results to return) using the corresponding modes of a multi-mode optical signal for each of the memory devices 316 . . . 322. Optionally, in one embodiment, as described above, additional modes may be provided for each memory device 316 . . . 322 for providing data to the GPU 302, such that upstream and downstream communication between the GPU 302 and memory devices 316 . . . 322 may be performed simultaneously using the optical multi-mode bus 308. For example, a third mode (λ₁′) of an optical multi-mode signal may be used to communicate data from the first memory device 316 to the GPU 302 via the optical multi-mode bus 308 while a fourth mode (λ₂′) of an optical multi-mode signal may be used to communicate data from the second memory device 318 to the GPU 302 via the optical multi-mode bus 308.

Those skilled in the art will recognize that timing and order of steps of the previously described method 400 may vary. In some embodiments each memory may respond individually to read requests, while in other embodiments the responses from one or more memories may be combined into an optical multi-mode transmission. Also, in general, any packaging or connection type may be used to connect components of the system 300. In one embodiment of the invention, the optical interface device 312 and the memories 316 . . . 322 may be placed on a same printed circuit board of the memory module 310 or in a multi-chip package using any appropriate bonding and connection techniques. Embodiments of the invention may also be used with an optical interface device 312 and memories 316 . . . 322 which are not in a single memory module 310 or connected using a single printed circuit board.

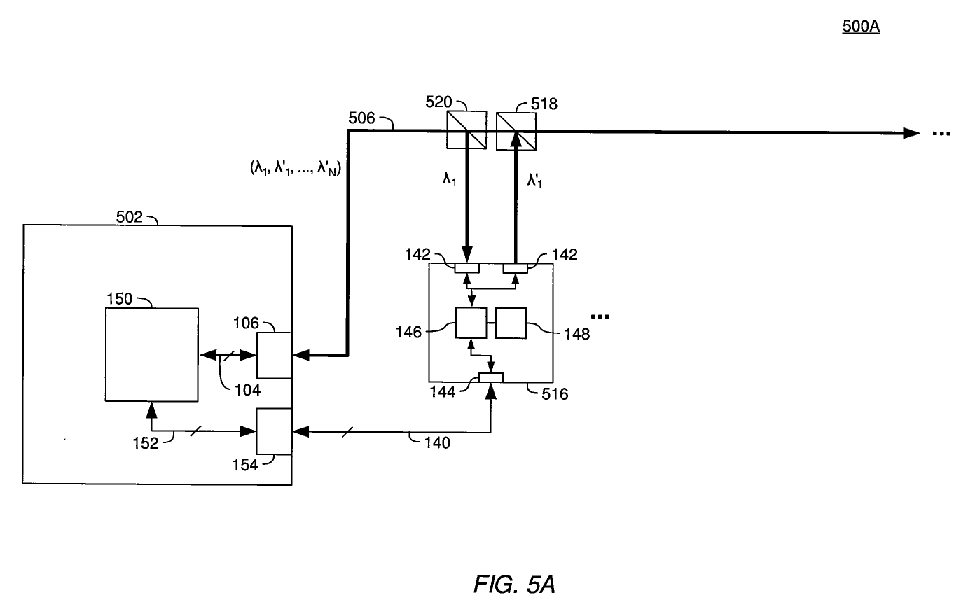

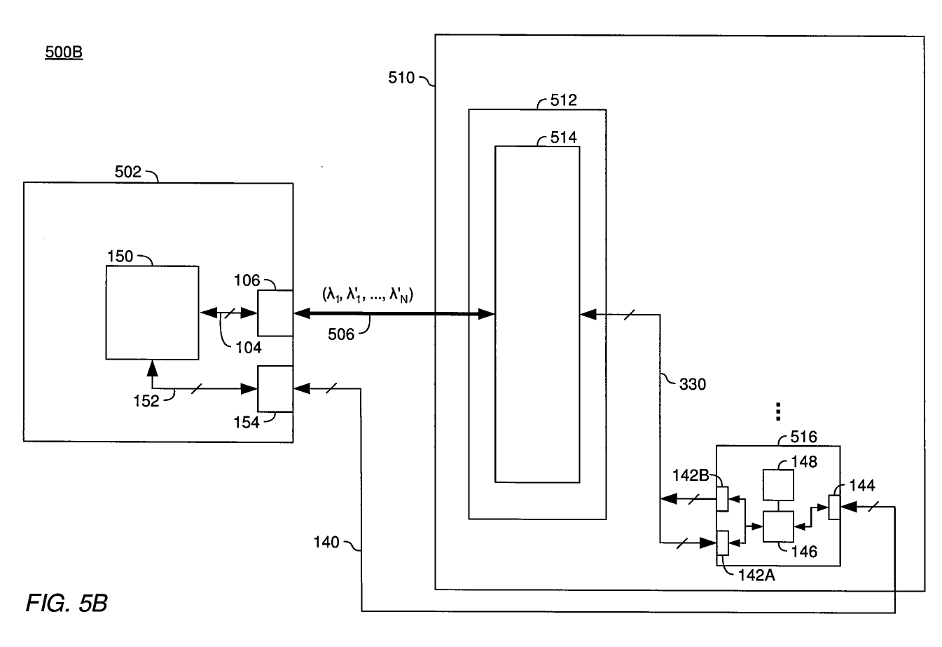

As mentioned above, in some cases, two or more modes (e.g., λ₁, λ₁′) of an optical multi-mode signal may be used to communicate between a GPU and a single memory device. For example, the two or more modes may be used to simultaneously provide information to and receive information from the single memory device, wherein a first mode (λ₁) is used for providing information (e.g., during a write operation) and wherein a second mode (λ₁′) is used for receiving information (e.g., during a read operation). FIGS. 5A and 5B are diagrams depicting systems 500A, 500B in which a GPU 502 uses two or more modes of an optical multi-mode signal to communicate with a single memory device 516 according to embodiments of the invention.

In one embodiment, as depicted in FIG. 5A, simultaneous bidirectional communication may occur via an optical multi-mode bus 506. A first beam splitter/filter 520 is used to split and filter a first mode (λ₁) of an optical signal received from the GPU 502 and directed to the memory device 516. A second beam splitter/filter 518 is used to provide a second mode (λ₁′) of the optical signal received from the memory device 516 to the GPU 502. As an example, in one embodiment communications from the GPU 502 to the memory device 516 may use blue light while communications from the memory device 516 to the GPU 502 may use red light. While two distinct beam splitters/filters are depicted, those skilled in the art will recognize beam splitters/filters which allow multiple independent optical paths to pass through the same filter simultaneously may also be used.

FIG. 5B depicts the use of wavelength division multiplexing for communication between the GPU 502 and a memory module 510 according to one embodiment of the invention. As discussed above, wavelength division multiplexing allows multiple modes of an optical multi-mode signal to be carried across the single optical multi-mode bus 506 simultaneously. A first mode (λ₁) of the optical multi-mode signal may be used for communications from the GPU 502 to a single memory device 516 within the memory module 510 while a second mode (λ₁′) of the optical multi-mode signal may be used for communications from the single memory device 516 within the memory module 510 to the GPU 502.

As depicted in FIG. 5B, control circuitry 150 within the GPU 502 may generate electronic signals to communicate with the memory device 516. Those electronic signals may be provided via an internal electronic bus 104 of the GPU 502 to a wavelength division multiplexer 106. The electronic signals may then be converted to an optical signal and transmitted via the optical multi-mode bus 506 as a first mode of the optical signal. An optical interface device 510 within the memory module 510 may receive the optical signal from the GPU 502. A wavelength division modulator 514 within the optical interface device may convert the received first mode (λ₁) of the optical signal into electrical signals which may, for example, be provided to receiver circuitry 142A of the memory device 516.

Where the memory device 516 transmits data to the GPU 502, transmitter circuitry 142B of the memory device 516 may provide the data to the optical interface device 512 via the electrical bus 330. The wavelength division multiplexer 514 within the optical interface device 512 may then convert the data received from the memory device 516 into a second mode (λ₁′) of an optical signal which may be transmitted via the multi-mode optical bus 506 to the GPU 502. Because transmissions from the GPU 502 to the memory device 516 may use first mode (λ₁) of an optical signal while transmissions from the memory device 516 to the GPU 502 may use a second mode (λ₁′) of the optical signal, each of the transmissions (to and from a given device) may be performed simultaneously without interference. Also, while only a single memory 516 is depicted in FIGS. 5A and 5B, those skilled in the art will also recognize a plurality of memories may also be used for simultaneous bilateral communication with the GPU 502.

In one embodiment of the invention, multiple modes of an optical signal may be used to communicate with two or more ports of a multiple port memory device simultaneously. For example, in one embodiment, a single GPU may be configured to access a first port of a memory device using a first mode (λ₁) of an optical multi-mode signal while the GPU may be configured to simultaneously access a second port of the memory device using a second mode (λ₂) of the optical multi-mode signal. Optionally, in one embodiment, multiple GPUs may be used to access multiple ports of a single memory device simultaneously using separate modes of an optical for each port.

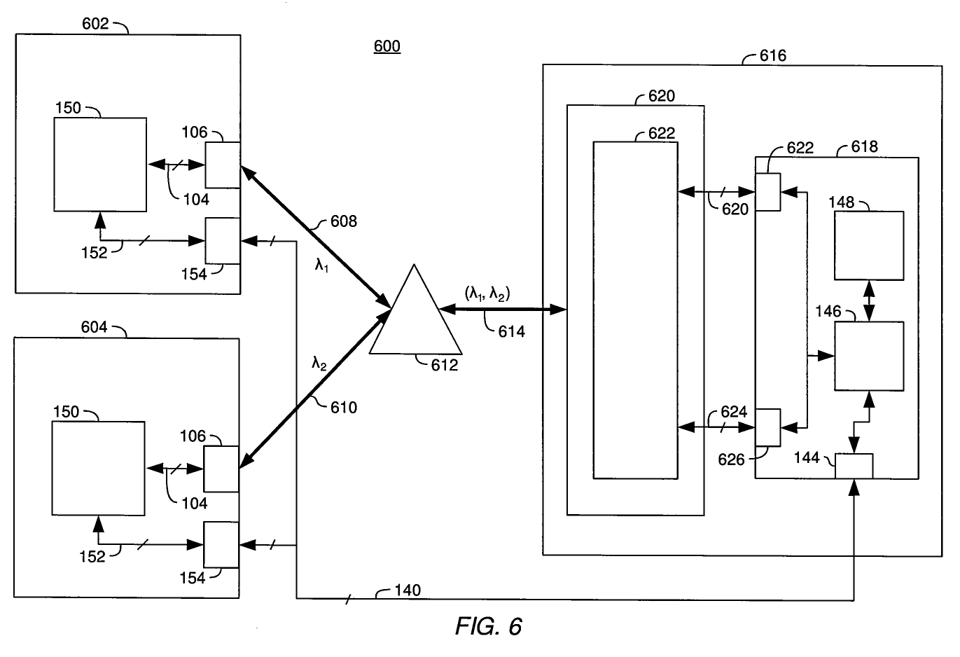

FIG. 6 depicts a system 600 in which a first GPU 602 and a second GPU 604 may access a dual port memory device 618 in a dual port memory module 616 according to one embodiment of the invention. Control circuitry 150 in the first GPU 602 may generate electrical signals which are provided via an internal electrical bus 104 to a wavelength division multiplexer 106 which converts the received electrical signals into a first mode (λ₁) of an optical signal which is transmitted via a first optical bus 608. Similarly, control circuitry 150 in the second GPU 604 may generate electrical signals which are provided via an internal electrical bus 104 to a wavelength division multiplexer 106 which converts the received electrical signals into a second mode (λ₂) of an optical signal which is transmitted via a second optical bus 610. The first mode (λ₁) of the optical signal from the first graphical processing unit 602 may be combined with the second mode (λ₂) of the optical signal from the second graphical processing unit 604 at a prism 612. The combined signals (λ₁, λ₂) may then be transmitted, via an optical multi-mode bus 614, to the dual port memory module 616.

The dual port memory module 616 may contain an optical interface device 620. The optical interface device 620 may use a wavelength division multiplexer 622 to separate the first and second modes (λ₁, λ₂) of the combined optical signals from the first graphical processing unit 602 and the second graphical processing unit 604. Once the signals are separated, the optical interface device 622 may convert the optical signals into electrical signals. In one embodiment, the optical interface device 620 may provide electrical signals corresponding to the first mode (λ₁) of the optical multi-mode signal to a first port 622 of the memory device 618 via a first electrical bus 620. The optical interface device 620 may also provide electrical signals corresponding to the second mode (λ₂) of the optical multi-mode signal to a second port 626 of the memory device 618 via a second electrical bus 624.

Thus, the first GPU 602 and the second GPU 604 may use a first and a second mode (λ₁, λ₂) respectively to simultaneously access a first port and a second port of the memory device 618 simultaneously. In one embodiment, the first mode and second mode (λ₁, λ₂) may also be used to return data from the memory device 618 to the first GPU 602 and the second GPU 604 simultaneously. For example, the wavelength division multiplexer 622 may combine the first and the second mode, intended for the first and the second GPU 602, 604, into an optical multi-mode signal. The optical multi-mode signal may be transmitted via the optical multi-mode bus 614 to the prism 612. The prism 612 may separate the optical multi-mode signal into the first and second modes, with the first mode (λ₁) being provided to the first GPU 602 via optical bus 608 and the second mode (λ₂) being provided to the second GPU 604 via optical bus 610.

In one embodiment of the invention, additional modes (e.g., a third mode and a fourth mode, λ₁′, λ₂′) may also be used to provide data from the memory device 618 to the first GPU 602 and the second GPU 604 simultaneously. Also, while depicted with respect to a single memory device 618 and two GPUs 602, 604, embodiments of the invention may be used with more than two GPUs and multiple memory devices (e.g., single port memory device, two-port memory devices, and/or multiple port memory devices) which may be accessed using additional modes as described above.

Those skilled in the art will also recognize that different modes may be used in order to enhance signal parallelism in the embodiments described above. For example, different modes may be used for data and for control signals and different modes may also be used for an associated clock signal. Also, while described above in some cases with respect to simultaneous communication using multiple modes, those skilled in the art will recognize that in some cases, the multiple modes may also be used individually to perform individual communications to a given device while other devices remain inactive, for example, waiting for further commands.

While the foregoing is directed to embodiments of the present invention, other and further embodiments of the invention may be devised without departing from the basic scope thereof, and the scope thereof is determined by the claims that follow.

What is claimed is:

1. A method for accessing one or more memory devices using an optical multi-mode signal, comprising:
providing an optical multi-mode signal including a first mode and a second mode, wherein the first mode corresponds to a first wavelength of light and wherein the second mode corresponds to a second wavelength of light; and
transmitting the optical multi-mode signal via an optical multi-mode bus to the one or more memory devices, wherein the first mode is used to perform a first access to the one or more memory devices and wherein the second mode is used to perform a second access to the one or more memory devices.

2. The method of claim 1, wherein the one or more memory devices are included in a memory module.

3. The method of claim 2, wherein the optical multi-mode signal is provided to an optical interface device included in the memory module.

4. The method of claim 1, wherein one or more beam splitting devices are used to separate the first mode and the second mode of the optical multi-mode signal and provide the first mode and the second mode to the one or more memory devices.

5. The method of claim 1, wherein the optical multi-mode signal is provided by a prism which receives the first mode from a first processor device and the second mode from a second processor device.

6. The method of claim 1, further comprising:
accessing a first memory device with the first mode of the optical multi-mode signal; and
accessing a second memory device with the second mode of the optical multi-mode signal.

7. The method of claim 1, further comprising:
performing a read access from a memory device using the first mode of the optical multi-mode signal; and
performing a write access to the memory device using the second mode of the optical multi-mode signal.

8. A memory device, comprising:
one or more memory arrays;
receiver circuitry configured to:
receive a first mode of an optical multi-mode signal, wherein the first mode is used to access the memory device, wherein the first mode corresponds to a first wavelength of light; and
convert the first mode of the optical multi-mode signal into electrical signals; and
control circuitry configured to receive one or more access commands via the electrical signals from the receiver circuitry.

9. The memory device of claim 8, wherein one or more beam splitting devices are used to separate the first mode and a second mode of the optical multi-mode signal and provide the first mode to the memory device.

10. The memory device of claim 8, further comprising:
transmitter circuitry configured to:
receive electrical signals indicating information to be transmitted from the memory device;
convert the electrical signals into the first mode of the optical multi-mode signal; and
transmit the first mode of the optical multi-mode signal via an optical bus.

11. The memory device of claim 8, further comprising:
transmitter circuitry configured to:
receive electrical signals indicating information to be transmitted from the memory device;
convert the electrical signals into a second mode of the optical multi-mode signal; and
transmit the second mode of the optical multi-mode signal via an optical bus.

12. An optical interface device, comprising:
circuitry configured to:
receive an optical multi-mode signal including a first mode and a second mode, wherein the first mode corresponds to a first wavelength of light and wherein the second mode corresponds to a second wavelength of light;
convert the first mode into a first electrical signal;
provide the first electrical signal to a first memory device;
convert the second mode into a second electrical signal; and
provide the second electrical signal to a second memory device.

13. The optical interface device of claim 12, wherein the circuitry is further configured to:
receive a third electrical signal from the first memory device;
convert the third electrical signal into a third mode of the optical multi-mode signal; and
transmit the third mode via an optical multi-mode bus.

14. The optical interface device of claim 12, wherein the first memory device and the optical interface device are included in a memory module.

15. The optical interface device of claim 12, wherein the optical multi-mode signal is received from a first processor device and a second processor device wherein the first mode of the optical multi-mode signal is received from the first processor device and the second mode of the optical multi-mode signal is received from the second processor device.

16. The optical interface device of claim 16, wherein the first mode and the second mode of the optical multi-mode signal are received from the first processor device and the second processor device via a prism.

17. A multi-chip module, comprising:
one or more memory devices; and
an optical interface device configured to:
receive an optical multi-mode signal including a first mode and a second mode, wherein the first mode corresponds to a first wavelength of light and wherein the second mode corresponds to a second wavelength of light;
convert the first mode into a first electrical signal;
provide the first electrical signal to a first one of the one or more memory devices;
convert the second mode into a second electrical signal; and
provide the second electrical signal to a second one of the one or more memory devices.

18. The multi-chip module of claim 17, wherein the optical interface device is further configured to:
receive a third electrical signal from the first one of the one or more memory devices;
convert the third electrical signal into a third mode of the optical multi-mode signal; and
transmit the third mode via an optical multi-mode bus.

19. The multi-chip module of claim 17, wherein the optical multi-mode signal is received from a first processor device and a second processor device wherein the first mode of the optical multi-mode signal is received from the first processor device and the second mode of the optical multi-mode signal is received from the second processor device.

20. The multi-chip module of claim 19, wherein the first mode and the second mode of the optical multi-mode signal are received from the first processor device and the second processor device via a prism.

21. A processor comprising:
circuitry configured to:
generate first electrical signals directed to a first memory device;
convert the first electrical signals into a first mode of an optical multi-mode signal; an
transmit the first mode of the optical multi-mode signal via an optical multi-mode bus to the first memory device, wherein the first mode is used to perform a first access to the first memory device;
generate second electrical signals directed to a second memory device;
convert the second electrical signals into a second mode of the optical multi-mode signal; and
transmit the optical multi-mode signal via the optical multi-mode bus to a second memory device, wherein the second mode is used to perform a second access to the second memory device.

22. The processor of claim 21, wherein the circuitry is further configured to:
generate third electrical signals directed to the first memory device and the second memory device;
convert the third electrical signals into a third mode of the optical multi-mode signal; and
transmit the optical multi-mode signal via the optical multi-mode bus to the first memory device and the second memory device, wherein the third mode is used to perform a third access to both the first memory device and the second memory device.

23. The processor of claim 21, wherein the circuitry is further configured to:
receive a fourth mode of an optical multi-mode signal from the first memory device via the optical multi-mode bus; and
convert the fourth mode of the optical multi-mode signal into electrical signals corresponding to a fourth access to the first memory device.

24. The processor of claim 21, wherein the optical multi-mode signal is provided by a prism which receives the first mode from the first processor and a fifth mode from a second processor.

25. A system, comprising:
one or more processors;
one or more memory devices;
an optical multimode bus configured to:
receive an optical multi-mode signal including a first mode and a second mode; and
provide the optical multi-mode signal to one or more memory devices, wherein the first mode is used to perform a first access to the one or more memory devices and wherein the second mode is used to perform a second access to the one or more memory devices.

26. The system of claim 25, wherein the one or more memory devices are included in a memory module.

27. The system of claim 25, further comprising:
an optical interface device in the memory module, wherein the optical multimode bus is configured to provide the optical multi-mode signal to the one or more memory devices using the optical interface device included in the memory module.

28. The system of claim 25, further comprising:
one or more beam splitting devices configured to separate the first mode and the second mode of the optical multi-mode signal and provide the first mode and the second mode to the one or more memory devices.

29. The system of claim 25, further comprising:
a prism which receives the first mode from a first processor device and the second mode from a second processor device and provides the optical multi-mode signal including the first mode and the second mode to the optical multi-mode bus.

30. The system of claim 25, wherein the system is configured to use the first mode of the optical multi-mode signal to access a first memory device with and use the second mode of the optical multi-mode signal to access a second memory device.

31. The system of claim 25, wherein the system is configured to perform a read access from a memory device using the first mode of the optical multi-mode signal and perform a write access to the memory device using the second mode of the optical multi-mode signal.

32. A system, comprising:
first means for processing;
one or more means for storing;
means for transmitting, configured to:
receive an optical multi-mode signal including a first mode and a second mode; and
provide the optical multi-mode signal to one or more memory devices, wherein the first mode is used to perform a first access to the one or more memory devices and wherein the second mode is used to perform a second access to the one or more memory devices.

33. The system of claim 32, wherein the one or more means for storing are included in a means for packaging.

34. The system of claim 32, further comprising:
means for interfacing in the means for storing, wherein the means for transmitting is configured to provide the optical multi-mode signal to the means for storing using the optical interface device included in the means for packaging.

35. The system of claim 32, further comprising:
means for separating configured to separate the first mode and the second mode of the optical multi-mode signal and provide the first mode and the second mode to the means for storing.

36. The system of claim 32, further comprising:
means for combining which receives the first mode from a first means for processing and the second mode from a means for processing and provides the optical multi-mode signal including the first mode and the second mode to the means for transmitting.

37. The system of claim 32, wherein the system is configured to use the first mode of the optical multi-mode signal to access a first means for storing with and use the second mode of the optical multi-mode signal to access a second means for storing.

38. The system of claim 32, wherein the system is configured to perform a read access from a single means for storing using the first mode of the optical multi-mode signal and perform a write access to the single means for storing using the second mode of the optical multi-mode signal.
